(19) United States
(12) Patent Application Publication
(10) Pub. No.: US 2025/0317858 A1
(43) Pub. Date: Oct. 9, 2025

(54) LOW-POWER SIGNALING AND BEAM FAILURE DETECTION

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Igor GUTMAN, Hod HaSharon (IL); Hemant SAGGAR, San Diego, CA (US); Jelena DAMNJANOVIC, Del Mar, CA (US)

(21) Appl. No.: 19/079,948

(22) Filed: Mar. 14, 2025

Related U.S. Application Data
(60) Provisional application No. 63/574,042, filed on Apr. 3, 2024.

(51) Int. Cl. H04W 52/02; H04W 24/08

(52) U.S. Cl. CPC H04W 52/0235; H04W 24/08

(57) ABSTRACT

Methods, systems, and devices for wireless communications are described. The method may include, by a user equipment (UE), receiving first control information indicative of a set of resources that the UE is to monitor for a low-power wake-up signal, monitoring, using an auxiliary radio of the UE, the set of resources for the low-power wake-up signal in accordance with the first control information, and transmitting, using a primary radio of the UE and based on failing to detect the low-power wake-up signal during the set of resources using the auxiliary radio, a control message indicative of the UE failing to detect the low-power wake-up signal during the set of resources.

### CROSS REFERENCES

The present Application for Patent claims benefit of U.S. Provisional Patent Application No. 63/574,042 by RYU et al., entitled “LOW-POWER WAKE-UP SIGNAL AND BEAM FAILURE DETECTION,” filed Apr. 3, 2024, assigned to the assignee hereof, and expressly incorporated herein.

### TECHNICAL FIELD

The following relates to wireless communications, including low-power signaling and beam failure detection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications systems may implement techniques for energy savings. For example, devices (e.g., UEs and network entities) may enter low power modes for durations, and during the low power modes, the devices may refrain from transmitting various signals or may not monitor for various signals.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control information indicative of a set of resources that the UE is to monitor for a low-power wake-up signal, monitoring, using an auxiliary radio of the UE, the set of resources for the low-power wake-up signal in accordance with the first control information, and transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive first control information indicative of a set of resources that the UE is to monitor for a low-power wake-up signal, monitor, using an auxiliary radio of the UE, the set of resources for the low-power wake-up signal in accordance with the first control information, and transmit, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

Another UE for wireless communications is described. The UE may include means for receiving first control information indicative of a set of resources that the UE is to monitor for a low-power wake-up signal, means for monitoring, using an auxiliary radio of the UE, the set of resources for the low-power wake-up signal in accordance with the first control information, and means for transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

A non-transitory computer-readable medium storing code for wireless communications is described. The code may include instructions executable by one or more processors (e.g., directly, indirectly, after pre-processing, without pre-processing) to receive first control information indicative of a set of resources that the UE is to monitor for a low-power wake-up signal, monitor, using an auxiliary radio of the UE, the set of resources for the low-power wake-up signal in accordance with the first control information, and transmit, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

In some examples of the method, user equipment (UEs), and non-transitory computer-readable medium described herein, transmitting the control message may include operations, features, means, or instructions for transmitting an uplink scheduling request message indicative of the UE failing to detect the low-power wake-up signal during the set of resources.

In some examples of the method, user equipment (UEs), and non-transitory computer-readable medium described herein, transmitting the control message may include operations, features, means, or instructions for transmitting, in a random access channel, a signal including a random access channel preamble, where the signal may be indicative of the UE failing to detect the low-power wake-up signal during the set of resources.

In some examples of the method, user equipment (UEs), and non-transitory computer-readable medium described herein, the control message may be transmitted based on the UE failing to detect the low-power wake-up signal in a threshold quantity of resources of the set of resources.

Some examples of the method, user equipment (UEs), and non-transitory computer-readable medium described herein may further include operations, features, means, or instructions for receiving second control information indicative of the threshold quantity of resources associated with triggering transmission of the control message indicative of the UE failing to detect the low-power wake-up signal during the set of resources.

In some examples of the method, user equipment (UEs), and non-transitory computer-readable medium described herein, refraining, based on failing to detect the low-power wake-up signal, from monitoring for the low-power wake-up signal during one or more resources of the set of resources.

Some examples of the method, user equipment (UEs), and non-transitory computer-readable medium described herein may further include operations, features, means, or instructions for monitoring, based on failing to detect the low-power wake-up signal and using the primary radio of the UE, for control messages during a physical downlink control channel resource.

In some examples of the method, user equipment (UEs), and non-transitory computer-readable medium described herein, monitoring for the control messages may include operations, features, means, or instructions for monitoring for the control messages during an on duration of a discontinuous reception cycle.

Some examples of the method, user equipment (UEs), and non-transitory computer-readable medium described herein may further include operations, features, means, or instructions for receiving second control information that indicates that the UE may be to monitor for the control messages during a physical downlink control channel resource in response to failing to detect the low-power wake-up signal, where the UE monitors for the control messages based on the second control information.

Some examples of the method, user equipment (UEs), and non-transitory computer-readable medium described herein may further include operations, features, means, or instructions for receiving, in response to transmitting the control message, second control information that indicates that the UE may be to deactivate low-power wake-up signal monitoring during the set of resources.

In some examples of the method, user equipment (UEs), and non-transitory computer-readable medium described herein, the low-power wake-up signal includes an on-off keying signal and the method, apparatuses, and non-transitory computer-readable medium may include further operations, features, means, or instructions for attempting to demodulate, using the auxiliary radio, the low-power wake-up signal without using inverse fast Fourier transform based on one or more characteristics associated with the low-power wake-up signal.

A method for wireless communications by a UE is described. The method may include receiving first control information indicative of a set of resources that the UE is to monitor for one or more low-power signals, monitoring, using a first beam and an auxiliary radio of the UE, the set of resources for the one or more low-power signals in accordance with the first control information, and transmitting, using the auxiliary radio or a primary radio of the UE and based on the one or more low-power signals failing to satisfy a measurement threshold on the first beam, a message indicative of the one or more low-power signals failing to satisfy the measurement threshold.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive first control information indicative of a set of resources that the UE is to monitor for one or more low-power signals, monitor, using a first beam and an auxiliary radio of the UE, the set of resources for the one or more low-power signals in accordance with the first control information, and transmit, using the auxiliary radio or a primary radio of the UE and based on the one or more low-power signals failing to satisfy a measurement threshold on the first beam, a message indicative of the one or more low-power signals failing to satisfy the measurement threshold.

Another UE for wireless communications is described. The UE may include means for receiving first control information indicative of a set of resources that the UE is to monitor for one or more low-power signals, means for monitoring, using a first beam and an auxiliary radio of the UE, the set of resources for the one or more low-power signals in accordance with the first control information, and means for transmitting, using the auxiliary radio or a primary radio of the UE and based on the one or more low-power signals failing to satisfy a measurement threshold on the first beam, a message indicative of the one or more low-power signals failing to satisfy the measurement threshold.

A non-transitory computer-readable medium storing code for wireless communications is described. The code may include instructions executable by one or more processors (e.g., directly, indirectly, after pre-processing, without pre-processing) to receive first control information indicative of a set of resources that the UE is to monitor for one or more low-power signals, monitor, using a first beam and an auxiliary radio of the UE, the set of resources for the one or more low-power signals in accordance with the first control information, and transmit, using the auxiliary radio or a primary radio of the UE and based on the one or more low-power signals failing to satisfy a measurement threshold on the first beam, a message indicative of the one or more low-power signals failing to satisfy the measurement threshold.

Some examples of the method, user equipment (UEs), and non-transitory computer-readable medium described herein may further include operations, features, means, or instructions for incrementing a beam failure counter based on the one or more low-power signals failing to satisfy the measurement threshold, where the message may be transmitted based on the beam failure counter satisfying a beam failure counter threshold.

In some examples of the method, user equipment (UEs), and non-transitory computer-readable medium described herein, the UE measures the one or more low-power signals for beam failure detection based on the first control information indicative of the set of resources that the UE may be to monitor for the one or more low-power signals.

In some examples of the method, user equipment (UEs), and non-transitory computer-readable medium described herein, the one or more low-power signals include one or more low-power wake-up signals, one or more low-power synchronization signals, or both.

Some examples of the method, user equipment (UEs), and non-transitory computer-readable medium described herein may further include operations, features, means, or instructions for receiving second control information indicative of a set of candidate beam reference signals that includes the one or more low-power signals.

In some examples of the method, user equipment (UEs), and non-transitory computer-readable medium described herein, the second control information may be indicative of the measurement threshold for the one or more low-power signals that may be different from a second measurement threshold associated with other candidate beam reference signals included in the set of candidate beam reference signals.

Some examples of the method, user equipment (UEs), and non-transitory computer-readable medium described herein may further include operations, features, means, or instructions for selecting, based on the one or more low-power signals failing to satisfy the measurement threshold, a second beam for communications, where the message may be transmitted using the second beam.

In some examples of the method, user equipment (UEs), and non-transitory computer-readable medium described herein, selecting the second beam may include operations, features, means, or instructions for selecting the second beam based on a measurement of the second beam satisfying a second beam measurement threshold associated with the second beam.

In some examples of the method, user equipment (UEs), and non-transitory computer-readable medium described herein, the second beam may be associated with a second low-power signal included in a candidate beam reference signal list.

In some examples of the method, user equipment (UEs), and non-transitory computer-readable medium described herein, the message indicates a beam failure on the first beam.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low-power signaling and beam failure detection in accordance with one or more aspects of the present disclosure.

FIG. 2 shows an example of a wireless communications system that supports low-power signaling and beam failure detection in accordance with one or more aspects of the present disclosure.

FIG. 3 shows an example of a communication timeline that supports low-power signaling and beam failure detection in accordance with one or more aspects of the present disclosure.

FIG. 4 shows an example of a communication timeline that supports low-power signaling and beam failure detection in accordance with one or more aspects of the present disclosure.

FIG. 5 shows an example of a process flow that supports low-power signaling and beam failure detection in accordance with one or more aspects of the present disclosure.

FIG. 6 shows an example of a process flow that supports low-power signaling and beam failure detection in accordance with one or more aspects of the present disclosure.

FIGS. 7 and 8 show block diagrams of devices that support low-power signaling and beam failure detection in accordance with one or more aspects of the present disclosure.

FIG. 9 shows a block diagram of a communications manager that supports low-power signaling and beam failure detection in accordance with one or more aspects of the present disclosure.

FIG. 10 shows a diagram of a system including a device that supports low-power signaling and beam failure detection in accordance with one or more aspects of the present disclosure.

FIGS. 11 through 13 show flowcharts illustrating methods that support low-power signaling and beam failure detection in accordance with one or more aspects of the present disclosure.

### DETAILED DESCRIPTION

Wireless communications systems may implement techniques to support power savings at user equipments (UEs) and network entities. For example, devices may utilize low-power signals to support power savings at various devices, such as UEs and network entities. Some UEs may be equipped with a main radio and a low-power radio. The main radio may be in an OFF mode while the low-power radio monitors for low-power signals such as a low-power wake-up signal (LP-WUS) or a low-power synchronization signal (LP-SS). If the UE detects a LP-WUS at the low-power radio, the UE may activate the main radio to monitor for downlink transmissions, such as physical downlink control channel (PDCCH) transmissions. In some cases, these techniques may be implemented with connected mode discontinuous reception (C-DRX) techniques, whereby the UE monitors the LP-WUS to determine whether to activate the main radio and monitor for the PDCCH during a C-DRX On-duration. If the LP-WUS does not include an indication (e.g., identifier) of the UE, the UE may suppress activation of the main radio for the on-duration (e.g., may skip monitoring for additional signals during the on-duration), which may further support power savings. Additionally, the UE may receive the LP-WUS during an off-duration of the main radio, such as to allow the UE to wake-up and monitor/receive PDCCH using the main radio.

Low-power signals may be low complexity signals (e.g., simple waveform) such as on-off keying (OOK) type 1 (OOK-1) and OOK type 2 (OOK-4) so that the low-power radio may efficiently process the signal. However, due to the low-power signals having low complexity, the range of such signals is not the same as other types of signals, even if transmitted at the same power. As such, UEs may be monitoring for the LP-WUS, but may not receive the LP-WUS due to being out of range (or beam misalignment). In such cases, the UE may fail to receive downlink communications.

In accordance with techniques described herein, a UE monitors for a LP-WUS during configured LP-WUS resources (e.g., LP-WUS occasions), and, responsive to failure to detect the LP-WUS, the UE transmits a control message indicative of failure to detect a LP-WUS in the configured LP-WUS resources. The UE may transmit the control message using physical random access channel (PRACH) resource or using an uplink (UL) scheduling request. The UE may then cease LP-WUS monitoring and monitor for PDCCH (e.g., using the main radio). The PDCCH monitoring may be performed in a C-DRX on-duration of a C-DRX cycle. After transmitting the control message, the UE may suppress monitoring the LP-WUS (e.g., until detection of a PDCCH using a main radio, receipt of a control message from the network, or for a configured duration). Additionally, the UE may use low-power signals (e.g., LP-WUS and/or low-power synchronization signal (LP-SS)) for beam failure detection. A threshold associated with beam failure detection or beam selection using low-power signals may be different from thresholds associated with other signals used for such purposes. The low-power signals may be included in a candidate beam reference list configured at the UE. These and other techniques are described in further detail with respect to the figures.

Aspects of the disclosure are initially described in the context of wireless communications systems. Aspects of the disclosure are further described with respect to a wireless communications system illustrating low-power signal transmissions, various communication timelines, and process flows. Aspects of the disclosure are further illustrated by and described with reference to apparatus diagrams, system diagrams, and flowcharts that relate to low-power signaling and beam failure detection.

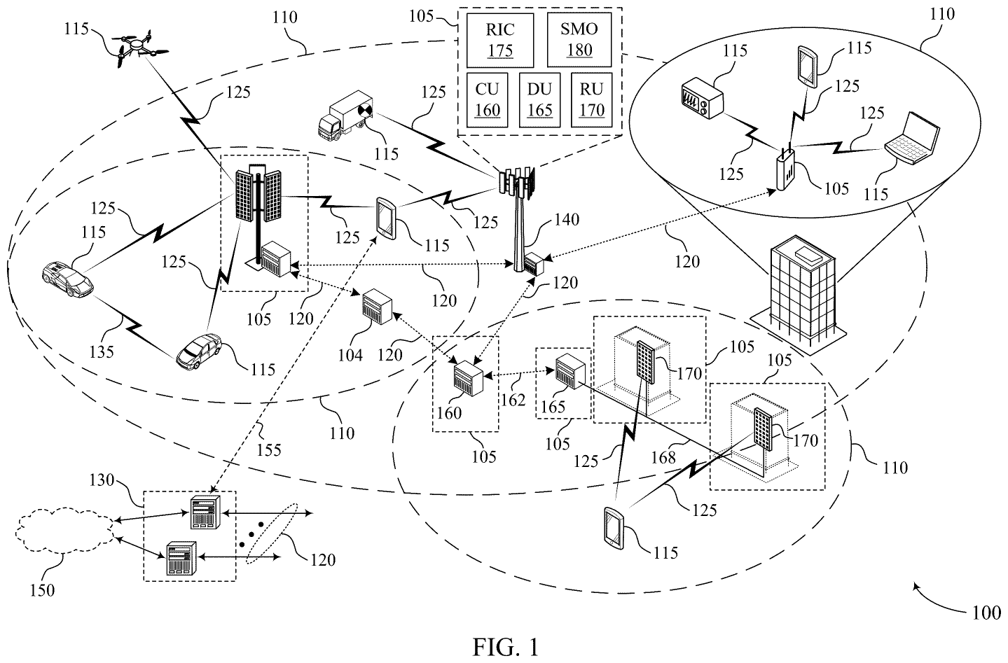

FIG. 1 shows an example of a wireless communications system 100 that supports low-power signaling and beam failure detection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140). Components within a wireless communication system may be coupled (for example, operatively, communicatively, functionally, electronically, and/or electrically) to each other.

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support low-power signaling and beam failure detection as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

UEs 115 and network entities may implement techniques for power savings. For example, some UEs 115 may be equipped with a main radio and a low-power radio (e.g., a low-power wake up radio). The main radio may be in an OFF mode while the low-power radio monitors for low-power signals such as a LP-WUS or a LP-SS. If the UE detects a LP-WUS at the low-power radio, the UE may activate the main radio to monitor for downlink transmissions, such as PDCCH transmissions. However, these low-power signals, due to low complexity characteristics, may have limited range relative to other types of signals transmitted at a same transmit power. As such, UEs 115 may be monitoring for the LP WUS, but may not receive the LP-WUS due to being out of range (or beam misalignment). In such cases, the UEs 115 may fail to receive some downlink communications.

Techniques described herein support UEs 115 notifying network entities 105 when the UEs 115 fail to detect a LP-WUS during configured LP-WUS resources. For example, the UE 115 transmits a control message indicative of failure to detect a LP-WUS in the configured LP-WUS resources. The UE 115 may transmit the control message using PRACH resources or via an uplink scheduling request. The UE 115 may then suppress LP-WUS monitoring and monitor for regular PDCCH (e.g., using the main radio). The PDCCH monitoring may be performed in a DRX on-duration (e.g., ON periods or ON durations) of a DRX cycle. After transmitting the control message, the UE may suppress monitoring the LP-WUS. The UE 115 may suppress LP-WUS monitoring based on receipt of a signal from the network entity 105. Additionally, or alternatively, the UE 115 may suppress LP-WUS monitoring after transmitting the control message for a configured duration, a quantity of LP-WUS monitoring occasions, and/or until receipt of a PDCCH/DCI using the main radio. Additionally, techniques described herein support UEs 115 using low-power signals (e.g., LP-WUS and/or LP-SS) for beam failure detection and beam selection.

In some examples, a UE 115 may receive a DRX mode configuration that indicates for the UE 115 to monitor for PDCCH transmissions using a main radio of the UE 115, wherein the monitoring is triggered by LP-WUS transmissions received using a low-power wake-up radio (LP-WUR) of the UE 115, and wherein the LP-WUR is a different radio relative to the main radio. The UE 115 may perform one or more measurements using the LP-WUR of the UE 115.

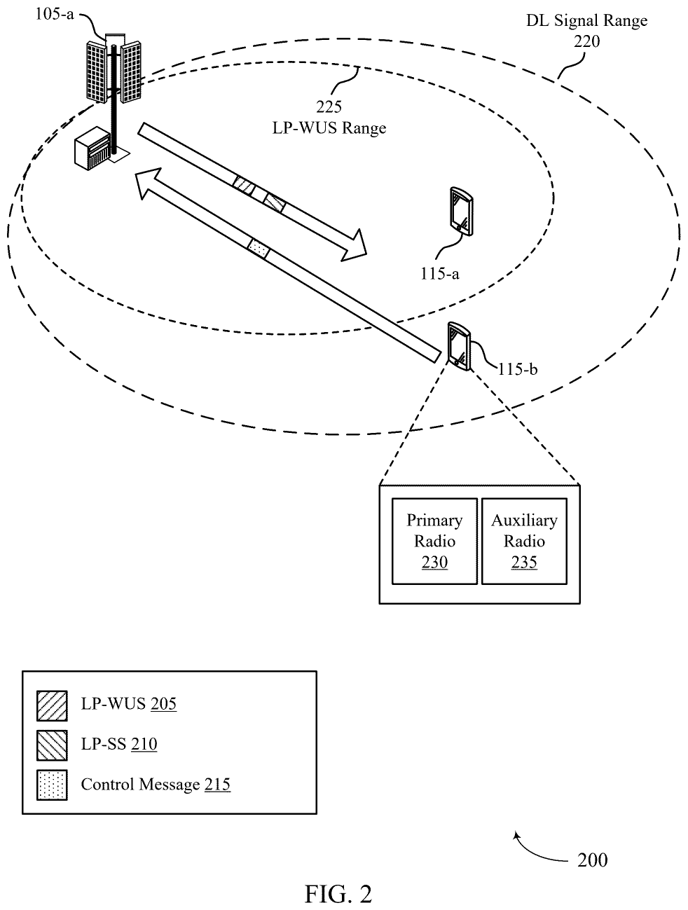

FIG. 2 shows an example of a wireless communications system 200 that supports low-power signaling and beam failure detection in accordance with one or more aspects of the present disclosure. The wireless communications system 200 may implement or be implemented by aspects of the wireless communications system 100 as described with reference to FIG. 1. For example, the wireless communications system 200 may include a UE 115-a, a UE 115-b, and a network entity 105-a, which may represent examples of corresponding devices described herein, including with reference to FIG. 1 (e.g., UEs 115, network entities 105).

The UEs 115 and the network entity 105-a of the wireless communications system 200 may implement techniques for power savings. For example, the network entity 105-a and the UEs 115 may support a power savings procedure using LP-WUS (e.g., a LP-WUS 205) for UEs that are in RRC idle and RRC connected modes. Additionally, the network entity 105-a and the UEs 115 may use LP-SS for power savings procedures, and the LP-SS may be an example of a broadcast signal that may be transmitted on multiple beams by the network entity 105-a. To support UE power savings, UEs 115 may be configured with two types of radios/receivers. For example, the UE 115-b includes a primary radio 230, which may be an example of a main radio/receiver (MR) and an auxiliary radio 235, which may be an example of a lower-power wake up radio/receiver (LP-WUR). The primary radio 230 may draw more power than the auxiliary radio 235. Additionally, the auxiliary radio 235 may have reduced capabilities relative to the primary radio 230. For example, the auxiliary radio 235 may be capable of doing a portion of demodulation techniques and decoding techniques relative to the primary radio 230. Additionally, the auxiliary radio 235 may have a limited bandwidth and/or DFT size relative to the primary radio 230.

The primary radio 230 and the auxiliary radio 235 may share the same or overlapping components, but some components may operate with lower power to support the auxiliary radio 235 (e.g., the low-power radio). That is, when the radio components (e.g., radio-frequency chain, antennas, analog-to-digital converter (ADC)) operate at full or relatively higher power, then the radio components may be considered the primary radio 230 (e.g., a primary radio mode). When the radio components are operating a lower power, then the radio components may be considered the auxiliary radio 235 (e.g., auxiliary radio mode). In some cases, however, the some or all components may be separate between the auxiliary radio 235 and the primary radio 230. For example, the primary radio 230 may use one or more main-processors for signal processing (and related functionality), and the auxiliary radio 235 may use one or more secondary processors (e.g., lower power or lower complexity processors). As described in further detail herein, because low-power signals may have reduced complexity, one or more components may operate with reduced capacity to process the low-power signals. For example, the ADC may operate at reduced capacity to process the lower bit-rate of the low-power signals relative to other signals.

To support power savings, the UEs 115-b may turn off the primary radio 230 to save power, as the primary radio 230 may draw more power than the auxiliary radio 235, and the auxiliary radio may be used to monitor for the LP-WUS 205. When the UE 115-b receives the LP-WUS 205 (or based on the LP-WUS 205 containing an indication or identifier for the UE 115-b), the UE 115-b may turn on or activate the primary radio 230 and monitor for various signals, such as PDCCH signaling, from the network entity 105-a. If the network entity 105-a has no control/data messages to send to the UE 115-b during the on-duration (while the on-duration timer is active), then the UE 115-b may deactivate or turn off the primary radio 230 to save power. For example, when the on-duration is initiated, the UE 115-b initiates the on-duration timer, and if the UE 115-b does not receive signaling while the on-duration timer is active, then the UE 115-b may deactivate the primary radio 230 for some period (e.g., until the next on-duration). If network entity 105-a has control/data message to send to the UE 115-b, the network entity 105-a may transmit the LP-WUS 205 that includes information that activates PDCCH monitoring for the UE 115-b. Additionally, or alternatively, if the UE 115-b has a control/data message to send to the network, then UE 115-b may activate the primary radio 230 and transmit the message to the network entity 105-a using the primary radio 230.

In some cases, the wireless communications system 200 may implement C-DRX procedures, as C-DRX may also support power savings at devices of the wireless communications system 200. In accordance with a C-DRX procedure, when the UE 115 is operating in connected mode, the UE 115 conserves battery power while still maintaining connectivity to the network. Instead of continuously monitoring for incoming data, which would quickly drain its battery, the UE 115 enters into a sleep-wake cycle. During the “sleep” periods (e.g., OFF periods), the UE 115 may power down receiver circuits to save energy. Then, at predetermined intervals set by the DRX cycle (e.g., the C-DRX configuration), the UE 115 “wakes up” for a short duration to check if there are any incoming transmissions on the PDCCH. If the UE 115 detects incoming data during these wake periods, the UE 115 stays awake a for a longer duration (determined by the inactivity timer) to receive the transmission. In some cases, the UE 115 might switch to a shorter DRX cycle if the UE 115 is to be more responsive to network communications. The network and the UE 115 agree on these timing parameters during initial setup. As a result, the UE 115 may extend battery life significantly while still remaining connected and responsive to the network. If there is no communication activity for the UE during the wake period, the UE 115 returns to its sleep state until a next scheduled wake-up time, continuing this cycle of power management.

In some cases, in accordance with C-DRX techniques, the UE 115 may be configured with multiple C-DRX cycles, each of which may include an active time and a sleep time. During the active time and while the on-duration timer (e.g., drx-onDurationTimer) or an inactivity timer (e.g., drx-InactivityTimer) is running, the UE 115 monitors the PDCCH on the serving cell. If the UE 115 receives a new transmission (e.g., downlink, uplink, or sidelink) in a serving cell, the UE 115 may start or restart the inactivity timer and extends the active time beyond the on-duration timer using the inactivity timer. The starting time-domain location (e.g., subframe) of a DRX cycle may be determined based on a DRX configuration parameter (e.g., drx-LongCycleStartOffset). Outside the active time (whether extended based on a received signal or not), the UE may be in an off-duration (or sleep state). In accordance with some techniques, the UE 115 may not wake up for each on-duration or active time in each DRX cycle. To support such techniques, the network entity 105-a may indicate, to the UE 115, that the UE 115 is to wake up for the next on-duration or active time in one or more of the next DRX cycles. The indication from the network entity 105-a may be in the form of a downlink control information (DCI) format 2_6 with cyclic-redundancy check (CRC) bits scrambled by power saving radio network temporary identifier (PS-RNTI), which may be referred to as a “DCP” signal. The DCP may be similar to a LP-WUS transmitted via DCI, but due to the complexity of the DCP, the DCP may be received and processed by the primary radio 230 and not the auxiliary radio 235. The UE 115 may be configured with resources during which to monitor for the DCP.

These C-DRX techniques may be used in conjunction with the UE having the primary radio 230 and the auxiliary radio 235 and the use of LP-WUS 205 to further improve power savings at the UEs 115. For example, in accordance with the C-DRX procedures, the PDCCH monitoring, using the primary radio 230, may be triggered by the LP-WUS 205 in accordance with a C-DRX configuration. In a first configuration, the LP-WUS monitoring may be performed, using the auxiliary radio 235, in accordance with the C-DRX configuration before a C-DRX on-duration timer (e.g., drx-onDurationTimer) to trigger initiation of the C-DRX on-duration timer. For example, the LP-WUS may be used to trigger the on-duration (or wake cycle), when the primary radio 230 may be used for PDCCH monitoring. If the UE does not receive a LP-WUS to trigger the on-duration, then the UE does not enter the on-duration and does not activate the primary radio 230. This first configuration may be used instead of using the DCP techniques described herein. In a second configuration, the LP-WUS may be monitored, via the auxiliary radio 235, outside a C-DRX active time according to the LP-WUS monitoring configuration. The LP-WUS 205 may trigger PDCCH monitoring, and the PDCCH monitoring may be irrespective of the on-duration timer. Accordingly, the LP-WUS monitoring occasions for the LP-WUS transmission may be scheduled prior in the time domain to each of the (or some) on-durations of the DRX mode.

As described herein, the LP-WUS 205 and the LP-SS 210 may be low complexity signals. For example, the LP-WUS 205 may be transmitted using a OOK-1and/or OOK-4 waveform. In the base band, the OOK waveform is a sequence of high power/amplitude (or ON) durations or low-power/amplitude (or OFF) durations. For example, eleven (11) physical resource blocks (PRBs) may be used for a LP-WUS with a subcarrier spacing of 30 kHz (for a first frequency range (FR1). Different quantities of resource blocks may be used for a second frequency range (FR2). A high/low application duration in a OOK waveform may be used to convey one or more information bits. For example, in accordance with OOK-1, one bit of information may be carried in one OFDM symbol (using the amplitude of the OOK-1 waveform). Additionality, in accordance with OOK-4, M bits of information may be carried in one OFDM symbol (using amplitude of OOK-4 waveform). An overlaid OFDM sequence may be a Gold sequence, M sequence, computer searched sequence, or Zadoff-Chu sequence. Because of the characteristics of the low-power signals, the UEs 115 may be able to demodulate or attempt to demodulate (e.g., using the auxiliary radio 235) the low-power signals without using inverse fast Fourier transform (I-FFT) techniques. Note that these ON/OFF durations are separate from the durations described with respect to C-DRX cycles.

In some cases, the information encoded in the LP-WUS 205 may include a bit for triggering PDCCH monitoring, a UE identifier for the target UE 115 (or the target UE group) to trigger PDCCH monitoring, or both. If the target UE 115 received the LP-WUS 205 that triggers PDCCH monitoring, the target UE 115 monitors the PDCCH using the primary radio 230. The network entity 105-a may configure resources (e.g., LP-WUS occasions) for the UE 115 to monitor for the LP-WUS 205, and the UE 115 may be expected to monitor and detect the presence of the LP-WUS 205 in the configured resources. For example, the network entity 105-a may transmit the LP-WUS in each of the configured resources, even if the LP-WUS 205 is not intended for the target UE 115. The information encoded in the LP-WUS 205 may support additional power savings, as the UE may not have to start monitoring PDCCH for each LP-WUS because the LP-WUS may contain information (e.g., UE or UE group identifier) that triggers the UE 115 to perform PDCCH monitoring.

Because of the nature of the LP-WUS 205 and the LP-SS 210 (e.g., using the OOK waveform), the signal range of the LP-WUS 205 and the LP-SS 210 may be low relative to other downlink signals that are transmitted with the same transmit power. Additionally, or alternatively, the LP-WUS transmission may be a narrowband signal that is transmitted with less transmit power than the downlink signal transmissions. In another example, the receive power capability of the LP-WUR may be less than the receive power capability of the main radio that would be used for the downlink transmissions to the UE. For example, the LP-WUR may be less complex than the main radio, such as being less sensitive than the main radio. Example signal ranges are illustrated in FIG. 2, where the LP-WUS 205 has a signal range 225, and other downlink signals have a signal range 220, even if the signals are transmitted by the network entity 105-a using the same transmit power. Thus, the LP-WUS 205 may be transmitted to the UE 115-b, but the UE 115-b may not receive the LP-WUS 205 due to the relatively limited range of the LP-WUS 205. As a result of failing to receive the LP-WUS 205, the UE 115-b may not wake-up the primary radio 230 to monitor for PDCCH and thus may fail to receive some data/control messages intended for the UE 115-b. However, the UE 115-a may receive the LP-WUS 205 due to being within the signal range 225.

As described in further detail herein, the UEs 115 may be configured to monitor for the LP-WUS 205 during one or more LP-WUS resources. For example, the UE may receive or otherwise obtain a LP-WUS configuration that identifies a set of monitoring occasions. Each monitoring occasion may identify time resources, frequency resources, spatial resources, or code resources that the UE is to monitor to receive a LP-WUS transmission. In some aspects, each monitoring occasion may occur prior in a time domain (e.g., just before, a threshold amount of time before) a corresponding on-duration of a DRX cycle. In some aspects, this may enable the network (e.g., the network entity 105-a) to configure resources for the UE to monitor for LP-WUS transmissions from the network. In some aspects, the UE may be expected to monitor and detect the presence of the LP-WUS transmission in all of the configured resources (e.g., in each monitoring occasion). That is, the network may transmit a LP-WUS in all configured resources of the LP-WUS configuration. The LP-WUS configuration may include a RSRP threshold for activating or deactivating LP-WUS monitoring. For example, if the UE measures RSRP below the configured RSRP threshold, the UE deactivates or does not activate LP-WUS monitoring. If the measured RSRP is above the threshold, the UE activates LP-WUS monitoring. The RSRP measurements may be based on downlink reference signals such as SSB or CSI-RS. If LP-WUS monitoring is activated, the UE may monitor for LP-WUS transmissions in LP-WUS monitoring occasions. If LP-WUS monitoring is deactivated, the UE may not monitor for LP-WUS transmissions in LP-WUS monitoring occasions and the UE may turn on the main radio and use it to monitor for PDCCH transmissions during the on-duration of the DRX cycle that occurs after deactivation.

In accordance with techniques described herein, if the UE 115-a fails to receive the LP-WUS 205 during one or more monitored resources, the UE 115 may transmit a control message 215 (e.g., using the primary radio 230) that is indicative of the failure to receive the LP-WUS 205. For example, one or more missed detections of LP-WUS 205 may trigger the UE 115-b to transmit the control message 215. Use of the control message 215 after detection failure of the LP-WUS 205 may support improved power savings and communication efficiency relative to the DCP techniques described herein. For example, in accordance with DCP techniques, if a UE misses a DCP, the UE either monitors PDCCH in the next on-duration of the DRX cycle or skips monitoring PDCCH. However, this technique may not be desirable for the LP-WUS. For example, a detection failure of LP-WUS 205 followed by subsequent PDCCH monitoring during the next scheduled on-duration creates an operational inefficiency that negates the intended power optimization of the LP-WUS 205 signaling. This behavior pattern is likely to persist due to the inherent coverage limitations of LP-WUS 205 compared to other downlink signals. The coverage differential creates a problematic scenario: if the UE 115 does not perform PDCCH monitoring after LP-WUS 205 detection failure, the UE 115 risks extended periods of PDCCH reception failure, potentially compromising network connectivity. Conversely, if the UE 115 defaults to PDCCH monitoring due to LP-WUS detection failure, the power saving advantages of the LP-WUS framework may be nullified or reduced, resulting in suboptimal power consumption characteristics. This creates a technical trade-off between maintaining reliable PDCCH reception and achieving the intended power efficiency of the LP-WUS mechanism, particularly in scenarios where LP-WUS detection reliability is compromised due to coverage limitations.

As described herein, the use of the control message 215 may address these trade-offs. For example, if the UE missies one or more LP-WUS transmissions in the configured LP-WUS resources (even if the LP-WUS does not include information to trigger the PDCCH monitoring by the UE 115-b), then the UE 115-b transmits the control message 215 that indicates that the UE 115-b is out of range or that a beam misalignment exists between the UE 115-b and the network entity. Thus, instead of the UE 115 waking-up during each subsequent on-duration (as a default) after one or more detection failures, which may drain power resources, the UE 115 informs the network of such failure, and the network entity 105-a and the UE 115-b can adapt to such conditions. For example, as described in further detail herein, the UE 115 may be configured to stop monitoring for the LP-WUS 205 after one or more detection failures or to perform beam reselection.

The control message 215 may be an example of a random access request sent via PRACH resources (e.g., random-access occasion). The PRACH signaling mechanism may be used by UEs 115 for informing the network about a beam failure and/or a new beam for which subsequent communications are to occur. Thus, the PRACH signaling technique may be useful in addressing LP-WUS detection failure as described herein. The control message may also in the form of a UE assistance-information (UAI) message.

The control message 215 may additionally, or alternatively, be an uplink scheduling request (SR) (sometimes referred to as a scheduling report). An SR is signaling mechanism employed by the UEs 115 to indicate to the network that it has uplink data pending for transmission but lacks the uplink resource allocation. The SR may be transmitted via the physical uplink control channel (PUCCH) or, in some cases, through the RACH procedure when no PUCCH resources are configured. After receiving an SR, the network entity 105-a may allocate appropriate uplink resources through a grant signaled on the PDCCH. The SR mechanism may be designed to be bandwidth-efficient, utilizing a single bit indication rather than conveying detailed buffer status information. This initial SR trigger may lead to the network scheduling an uplink grant that allows the UE 115 to transmit both data and a more detailed Buffer Status Report (BSR), enabling more precise resource allocation for subsequent transmissions. The timing and periodicity of SR opportunities are configured by the network.

The control message 215, whether in the form of or transmitted in PRACH signaling, a SR message, or a UAI message, may include additional information (e.g., one or more bits) that indicate that the UE 115-b failed to detect the LP-WUS during one or more of the configured LP-WUS monitoring occasions. In some cases, after LP-WUS detection failure, the UE 115-b may wake-up and monitor for PDCCH during the next on-duration of a C-DRX cycle. In such cases, the UE 115-b may refrain from monitoring for the LP-WUS in subsequent LP-WUS monitoring occasions until the LP-WUS parameters are reconfigured or until PDCCH triggered by LP-WUS is reactivated by the network entity 105-a. Additionally, or alternatively, the network entity 105-a may transmit information (e.g., via a downlink control signal) that the UE is to deactivate LP-WUS monitoring.

In some examples, the network entity 105-a may transmit control information (e.g., via RRC signaling) that indicates that the UE 115 is to monitor for PDCCH if LP-WUS is monitored but not detected during one or more LP-WUS monitoring occasions. For example, the RRC signaling may include a parameter (e.g., similar to a psWakeUp parameter) that includes a value (e.g., 1 or 0) that indicates whether the UE is to wake-up and monitor for PDCCH after one or more LP-WUS detection failures.

The network entity 105-a may also transmit control information that is indicative of a threshold quantity of resources (e.g., LP-WUS monitoring occasions) that is used to determine whether the UE is to transmit the control message 215 that indicates failure to detect the LP-WUS 205. Thus, if the UE 115-b fails to detect the LP-WUS in a quantity of LP-WUS monitoring occasions that satisfies (e.g., is greater than, is greater than or equal to) the threshold, then the UE transmits the control message 215.

Some wireless communications systems may specify that UEs 115 should perform various measurements (e.g., including beam failure detection related measurements) using the primary radio 230. However, if such measurements are to be performed using the primary radio, power saving capability may be limited, as the primary radio 230 is to be activated to perform such measurements.

Thus, according to techniques described herein, the UEs (e.g., the UE 115-b) may perform various measurements using the auxiliary radio 235. For example, if the UE 115-b is configured with DRX with PDCCH monitoring triggered by LP-WUS 205, the UE 115-b may perform measurement for beam failure detection using the receiver (e.g., the auxiliary radio 235) used for receiving the LP-WUS 205. Additionally, the UE 115-b may use the LP-SS 210 and/or the LP-WUS 205 for beam failure selection purposes. In accordance with such techniques, if the radio link quality or reference signal received power (RSRP) of the LP-SS 210 and/or the LP-WUS 205 is below a threshold, then the PHY layer of the UE may indicate the condition to higher layers. For example, if the RSRP of the LP-SS is below the threshold, then the PHY layer of the UE may notify the MAC layer, and the MAC layer may transmit, to the network entity 105-a, an instance of a beam failure indication. Additionally, the UE 115-b may increment an associated counter (e.g., beam failure indication (BFI) counter).

To support low-power beam failure measurement techniques, the LP-SS (and/or the LP-WUS) may be included in a candidate beam list (e.g., candidateBeamRSList) associated with beam failure detection or recovery. The candidate beam list may be indicative of reference signals/beams from which the UE 115-b is to select a new beam after beam failure detection. In beam failure recovery, the UE 115 may receive and measure synchronization signal blocks (SSBs) or channel state information reference signals (CSI-RS) that are included in the candidate beam list. If RSRP (or some other metric) is above an associated threshold, then UE 115-b may select that reference signal/beam as a new downlink beam. The UE 115 may then transmit PRACH in resources associated with the selected downlink beam to inform the network entity 105-a of the selected beam. In some cases, the LP-SS may be quasi-co-located (e.g., type D) with the SSBs, meaning that LP-SS may be transmitted on the same downlink beams as the SSB. Thus, the UE 115 may measure the LP-SS 210 (or LP-WUS 205) to perform beam failure detection and recovery. In some cases, the threshold associated with the LP-SS (or LP-WUS) for beam failure recovery may be different from a threshold associated with SSBs. The threshold may be different because the waveform is different, and since the auxiliary radio 235 is lower power, the measurements may be noisier (e.g., higher RSRP) than measurements using the primary radio 230. Thus, the threshold associated with measurement of the LP-SS 210 (or LP-WUS) using the auxiliary radio 235 may be configured higher than the thresholds associated with SSB measurements using the primary radio 230. For example, the low-power signal threshold is configured using a configuration or indication that is separate from the configuration or indication that is used to configure the threshold associated with the SSB measurements. Alternatively, the low-power signal threshold is configured using on offset (e.g., an indication of an offset) that is applied to the threshold that is configured for the SSB measurements, and application of the offset may result in the low-power signal threshold.

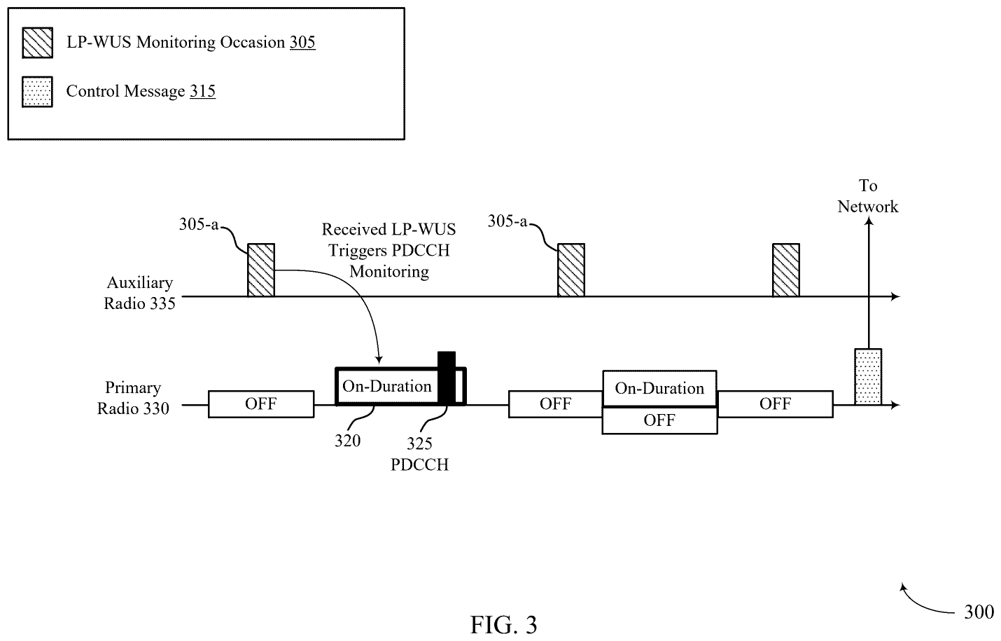

FIG. 3 shows an example of a communication timeline 300 that supports low-power signaling and beam failure detection in accordance with one or more aspects of the present disclosure. The communication timeline 300 may be implemented by aspects of the wireless communications system 100 and the wireless communications system 200 as described herein with respect to FIGS. 1 and 2. For example, the communication timeline may be implemented by the UEs 115 and network entities 105 as described with respect to FIGS. 1 and 2.

The communication timeline 300 illustrates example operations for LP-WUS monitoring according to the LP-WUS monitoring configuration before triggering the DRX on-duration timer (e.g., drx-onDurationTimer). The operations may be implemented by a UE 115 that includes a primary radio 330, which may be an example of the primary radio 230 of FIG. 2, and an auxiliary radio 335, which may be an example of the auxiliary radio 235 of FIG. 2.

The UE may be configured with a set of LP-WUS monitoring occasions 305, during which the UE monitors, using the auxiliary radio 335, for receipt of an LP-WUS. The UE may monitor for the LP-WUS during the LP-WUS monitoring occasions 305 while the primary radio 330 is in an OFF mode. If the UE receives the LP-WUS during one of the LP-WUS monitoring occasions 305, the UE may activate the primary radio 330 during the next C-DRX on-duration. For example, the UE receives the LP-WUS during the LP-WUS monitoring occasion 305-a, and the LP-WUS includes information (e.g., UE or UE group identifier) that triggers PDCCH monitoring during a next on-duration (e.g., on-duration 320) of the C-DRX cycle. When the on-duration is activated or initiated, the UE initiates the on-duration timer, and while the on-duration timer is active, the UE monitors the PDCCH for reception of a DCI using the primary radio. As illustrated in FIG. 3, the UE receives signaling in the PDCCH 325, which may trigger initiation of an inactivity timer. The UE may not monitor for PDCCH after the on-duration timer expires (e.g., if no DCI/PDCCH is received) or after the inactivity timer expires.

After expiration of one or more of the timers, the primary radio 330 may be switched to an OFF mode, and the UE continues monitoring for LP-WUS during the LP-WUS monitoring occasions 305. Thus, if the C-DRX configuration indicates utilization of the LP-WUS and if the UE does not receive the LP-WUS that triggers PDCCH monitoring (e.g., using the UE or UE group identifier) during the LP-WUS monitoring occasion 305, the UE may not start the on-duration timer (and may not activate the primary radio 330) in a DRX cycle that is subsequent to the LP-WUS monitoring occasions 305. Thus, as illustrated, the LP-WUS monitoring occasion 305-a does not include a LP-WUS that triggers PDCCH monitoring for the UE (e.g., the LP-WUS does not include an identifier for the UE or an identifier for a UE group including the UE), and as such, the primary radio 330 remains in the OFF mode during the next on-duration of the C-DRX cycle. As a result, the UE does not monitor for PDCCH or activate the on-duration timer.

However, as described herein, the UE may be out of range of the LP-WUS or the respective beams may be misaligned, and, as a result, the UE may not detect a LP-WUS during one or more of the LP-WUS monitoring occasions 305. Accordingly, after one or more failed detections of the LP-WUS during the LP-WUS monitoring occasions, the UE may transmit a control message 315 to the network. The control message 315 may be transmitted using the primary radio 330, and the control message 315 may be indicative of the UE's failure to detect the LP-WUS. In some cases, after detection failure during one or more LP-WUS monitoring occasions 305, the UE may be configured to activate the primary radio 330 (e.g., wake-up) and monitor for the PDCCH during the next on-duration of a DRX cycle. As described, this behavior may be configured by the network (e.g., using a parameter in RRC signaling).

According to aspects of the techniques described herein, when the UE is configured with DRX with PDCCH monitoring triggered by LP-WUS transmissions, the UE may use the main radio to perform various measurements as well as for receiving the LP-WUS transmissions.

For example, the UE may receive or otherwise obtain a DRX configuration that indicates for the UE to monitor the PDCCH using a main radio of the UE. The monitoring, in this aspect, may be triggered by LP-WUS transmissions received using the LP-WUR of the UE. However, the UE may use the LP-WUR to perform one or more measurements. The UE using the LP-WUR to perform the one or more measurements may be based on the UE being configured for DRX operations and being configured for PDCCH monitoring based on a LP-WUS trigger. The one or more measurements in this example may include, but are not limited to, radio resource management (RRM) measurements, radio link monitoring (RLM) measurements, beam failure detection (BFD) measurements, or channel state information (CSI) measurements.

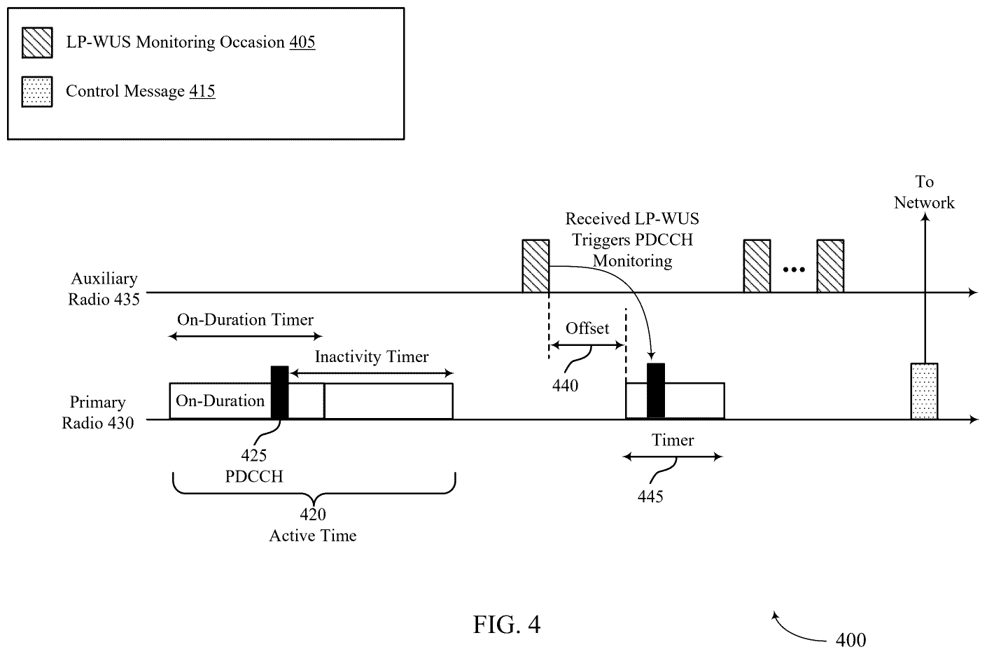

FIG. 4 shows an example of a communication timeline 400 that supports low-power signaling and beam failure detection in accordance with one or more aspects of the present disclosure. The communication timeline 400 may be implemented by aspects of the wireless communications system 100 and the wireless communications system 200 as described herein with respect to FIGS. 1 and 2. For example, the communication timeline may be implemented by the UEs 115 and network entities 105 as described with respect to FIGS. 1 and 2.

The communication timeline 400 illustrates example operations for LP-WUS monitoring outside C-DRX active times based on the LP-WUS monitoring configuration that triggers PDCCH monitoring. The operations may be implemented by a UE 115 that includes a primary radio 430, which may be an example of the primary radio 230 of FIG. 2, and an auxiliary radio 435, which may be an example of the auxiliary radio 235 of FIG. 2.

As illustrated, the UE may activate the primary radio during an on-duration of an active time 420 of the C-DRX cycle. If the UE receives a PDCCH/DCI (e.g., a PDCCH 425) during the on-duration, the UE may activate the inactivity timer and continue monitoring. When the inactivity timer expires (or the on-duration timer expires before a PDCCH/DCI is received), the UE switches the primary radio 430 to an OFF mode.

The UE may be configured with a set of LP-WUS monitoring occasions 405 for C-DRX. During the LP-WUS monitoring occasions 405, the UE monitors for, using the auxiliary radio 435, receipt of an LP-WUS. The UE may monitor for the LP-WUS during the LP-WUS monitoring occasions 405 while the primary radio 430 is in the OFF mode. If the UE receives the LP-WUS that includes an identifier for the UE or an identifier for a UE group including the UE during one of the LP-WUS monitoring occasions 405, the UE may activate the primary radio 430 and monitor for the PDCCH. However, instead of monitoring during the next on-duration of the C-DRX cycle (as discussed in FIG. 3), the UE may monitor (e.g., using the primary radio 430) after a fixed offset 440 after receiving the LP-WUS that triggers PDCCH monitoring. Additionally, the UE may monitor PDCCH while a monitoring timer 445 is active. The fixed offset 440, the monitoring timer 445, or both may be configured in association with the C-DRX configuration. The monitoring timer 445 may be different from the on-duration timer that is associated with an active time of the C-DRX cycle. For example, the on-duration timer may be activated when the on-duration starts for the C-DRX cycle, while the monitoring timer 445 may be dynamically activated by the LP-WUS. The duration of the on-duration timer and the monitoring timer 445 may be the same or different, and may be configured using the same or different signaling.

However, as described herein, the UE may be out of range of the LP-WUS or the respective beams may be misaligned, and, as a result, may not detect a LP-WUS during one or more of the LP-WUS monitoring occasions 405. Accordingly, after one or more failed detections of the LP-WUS during the LP-WUS monitoring occasions 405, the UE may transmit a control message 415 to the network. The control message 415 may be transmitted using the primary radio 430, and the control message 415 may be indicative of the UEs failure to detect the LP-WUS.

In some cases, after transmission of the control message 415, the network (e.g., the network entity 105) may transmit information (e.g., via a downlink control message) that indicates that the UE is to stop monitoring for the LP-WUS during the off-duration of the DRX cycle. As a result, the network may refrain from transmitting the LP-WUS during subsequent LP-WUS monitoring occasions 405, which may also support network power savings. In such cases, the downlink control message may also function as an acknowledgment that the network entity received the control message 415 transmitted by the UE.

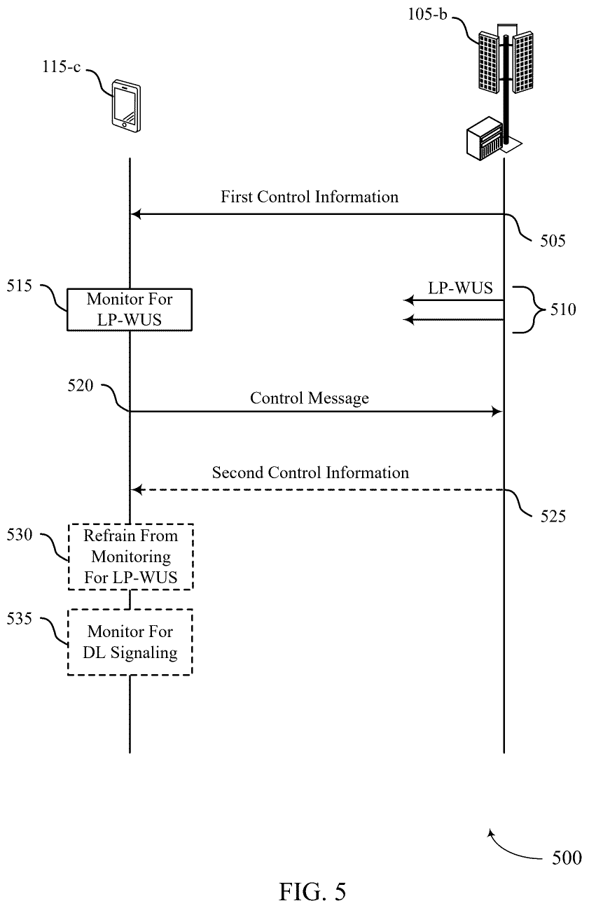

FIG. 5 shows an example of a process flow 500 that supports low-power signaling and beam failure detection in accordance with one or more aspects of the present disclosure. The process flow 500 may implement or be implemented to realize aspects of the wireless communications system 100 and the wireless communications system 200. For example, the process flow 500 may illustrate communication between a UE 115-c, and a network entity 105-b, which may be examples of corresponding devices described herein, including with reference to FIGS. 1 and 2 (e.g., UEs 115, network entities 105). Alternative examples of the following may be implemented. For example, some steps may be performed in a different order than described or may not be performed at all. In some implementations, operations may include additional features not mentioned below, or further operations may be added. Further, although the UE 115-c and the network entity 105-b are shown performing the operations of the process flow 500, some aspects of some operations may also be performed by one or more other wireless communication devices.

At 505, the UE 115-c may receive, from the network entity 105-b, first control information (e.g., a LP-WUS configuration) indicative of a set of resources (e.g., LP-WUS monitoring occasions) that the UE 115-c is to monitor for a LP-WUS. The first control information may be received in association with C-DRX configuration information and may be received via control signaling (e.g., RRC signaling). In some examples, the UE 115-c may receive second control information (e.g., in the same or different signaling including the first control information) that indicates a threshold quantity of resources associated with triggering transmission of a control message indicative of the UE 115-c failing to detect the low-power wake-up signal during the set of resources. Additionally, or alternatively, the UE 115-c may receive control information that indicates that the UE is to monitor for the control messages during a physical downlink control channel resource in response to failing to detect the low-power wake-up signal.

At 510, the network entity 105-b may transmit the LP-WUS during the one or more resources (e.g., the LP-WUS monitoring occasions), and, at 515, the UE may monitor, using an auxiliary radio of the UE, the set of resources for the LP-WUS in accordance with the first control information. In some cases, the UE 115-c may attempt to demodulate, using the auxiliary radio, the low-power wake-up signal without using I-FFT.

At 520, the UE 115-c may transmit, to the network entity 105-b, using a primary radio of the UE 115-c, and based on failing to detect the low-power wake-up signal during the set of resources using the auxiliary radio (e.g., in accordance with the monitoring), a control message indicative of the UE failing to detect the low-power wake-up signal during the set of resources. The control message may be an example of an uplink SR, a signaling in a RACH (e.g., a RACH occasion), or a combination thereof. In some cases, the control message is transmitted based on the UE 115-c failing to detect the LP-WUS in a threshold quantity of resources of the set of resources.

At 525, the UE 115-c may receive, from the network entity 105-b in response to transmitting the control message, second control information that indicates that the UE is to deactivate LP-WUS monitoring during the set of resources.

At 530, the UE 115-c may refrain, based on failing to detect the low-power wake-up signal and/or based on receiving the second control information, from monitoring for the LP-WUS during one or more resources of the set of resources.

At 535, the UE 115-c may monitor, based on failing to detect the LP-WUS and using the primary radio of the UE, for control messages during a PDCCH. The UE 115-c may monitor for such control messages during an on-duration of a DRX cycle. Additionally, or alternatively, the UE 115-c may monitor for such control messages based on the control information that indicates that the UE 115-c is to monitor for the control messages during the PDCCH in response to failing to detect the low-power wake-up signal.

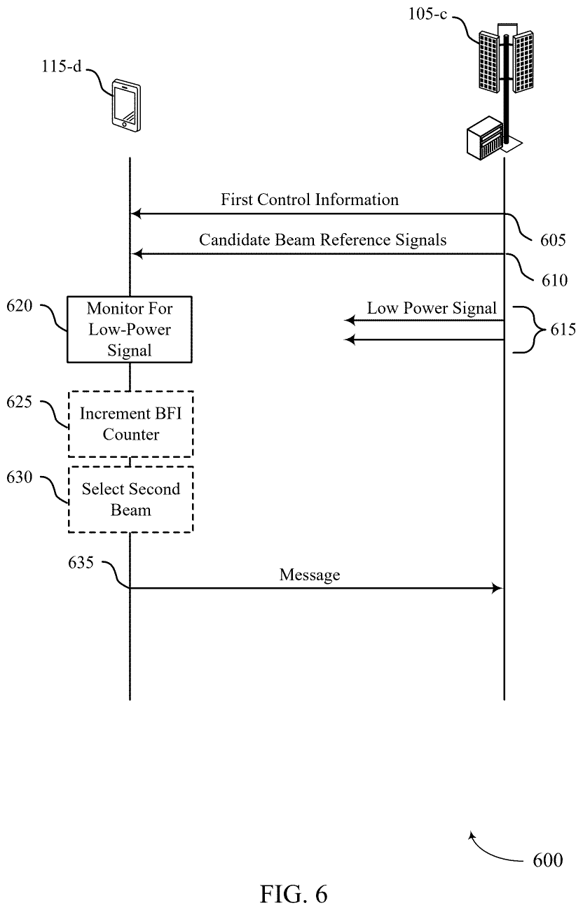

FIG. 6 shows an example of a process flow 600 that supports low-power signaling and beam failure detection in accordance with one or more aspects of the present disclosure. The process flow 600 may implement or be implemented to realize aspects of the wireless communications system 100 and the wireless communications system 200. For example, the process flow 600 may illustrate communication between a UE 115-d and a network entity 105-c, which may be examples of corresponding devices described herein, including with reference to FIGS. 1 and 2 (e.g., UEs 115, network entities 105). Alternative examples of the following may be implemented. For example, some steps may be performed in a different order than described or may not be performed at all. In some implementations, operations may include additional features not mentioned below, or further operations may be added. Further, although the UE 115-d and the network entity 105-c are shown performing the operations of the process flow 600, some aspects of some operations may also be performed by one or more other wireless communication devices.

At 605, the UE 115-d may receive, from the network entity 105-c, first control information indicative of a set of resources (e.g., LP-WUS monitoring occasions, LP-SS occasions) that the UE 115-c is to monitor for one or more low-power signals (e.g., LP-WUS, LP-SS). The first control information may be received in association with C-DRX configuration information and may be received via control signaling (e.g., RRC signaling). At 610, the UE 115-d may receive second control information (e.g., in the same or different signaling including the first control information) that indicates a set of candidate beam reference signals that include the one or more low-power signals (e.g., LP-SS). The UE 115-d may also receive or otherwise obtain a RSRP threshold for activating or deactivating LP-WUS monitoring. The RSRP threshold may be received in accordance with a discontinuous reception mode configuration

At 615, the network entity 105-b may transmit the one or more low-power signals during the one or more resources, and, at 620, the UE 115-d may monitor, using a first beam and an auxiliary radio of the UE 115-d, the set of resources for the one or more low-power signals in accordance with the first control information. In some cases, the UE 115-d may attempt to demodulate, using the auxiliary radio, the low-power signals without using I-FFT.

At 625, the UE 115-d may increment a beam failure counter based on the one or more low-power signals failing to satisfy the measurement threshold. In some cases, the message is transmitted based on the beam failure counter satisfying a beam failure counter threshold.

At 630, the UE 115-d may select, based on the one or more low-power signals failing to satisfy the measurement threshold, a second beam for communications. The second beam may be selected based on a measurement of the second beam satisfying a second beam measurement threshold associated with the second beam (e.g., the threshold is associated with LP-SS). In some cases, the second beam is associated with a second low-power signal included in the candidate beam reference signal list.

At 635, the UE 115-d may transmit, to the network entity 105-c, using the auxiliary radio or a primary radio of the UE 115-d, and based on the one or more low-power signals failing to satisfy a measurement threshold on the first beam, a message indicative of the one or more low-power signals failing to satisfy the measurement threshold. In some cases, the control message may be transmitted using the selected second beam. The message may indicate a beam failure on the first beam.

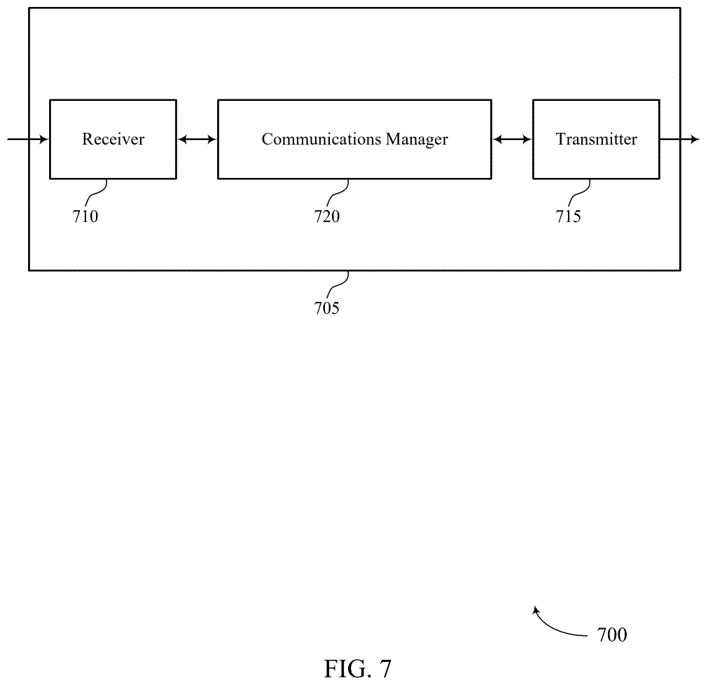

FIG. 7 shows a block diagram 700 of a device 705 that supports low-power signaling and beam failure detection in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to low-power signaling and beam failure detection). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to low-power signaling and beam failure detection). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of low-power signaling and beam failure detection as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving first control information indicative of a set of resources that the UE is to monitor for a low-power wake-up signal. The communications manager 720 is capable of, configured to, or operable to support a means for monitoring, using an auxiliary radio of the UE, the set of resources for the low-power wake-up signal in accordance with the first control information. The communications manager 720 is capable of, configured to, or operable to support a means for transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

Additionally, or alternatively, the communications manager 720 may support wireless communications in accordance with examples as disclosed herein. For example, the communications manager 720 is capable of, configured to, or operable to support a means for receiving first control information indicative of a set of resources that the UE is to monitor for one or more low-power signals. The communications manager 720 is capable of, configured to, or operable to support a means for monitoring, using a first beam and an auxiliary radio of the UE, the set of resources for the one or more low-power signals in accordance with the first control information. The communications manager 720 is capable of, configured to, or operable to support a means for transmitting, using the auxiliary radio or a primary radio of the UE and based on the one or more low-power signals failing to satisfy a measurement threshold on the first beam, a message indicative of the one or more low-power signals failing to satisfy the measurement threshold.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced power consumption and more efficient utilization of communication resources.

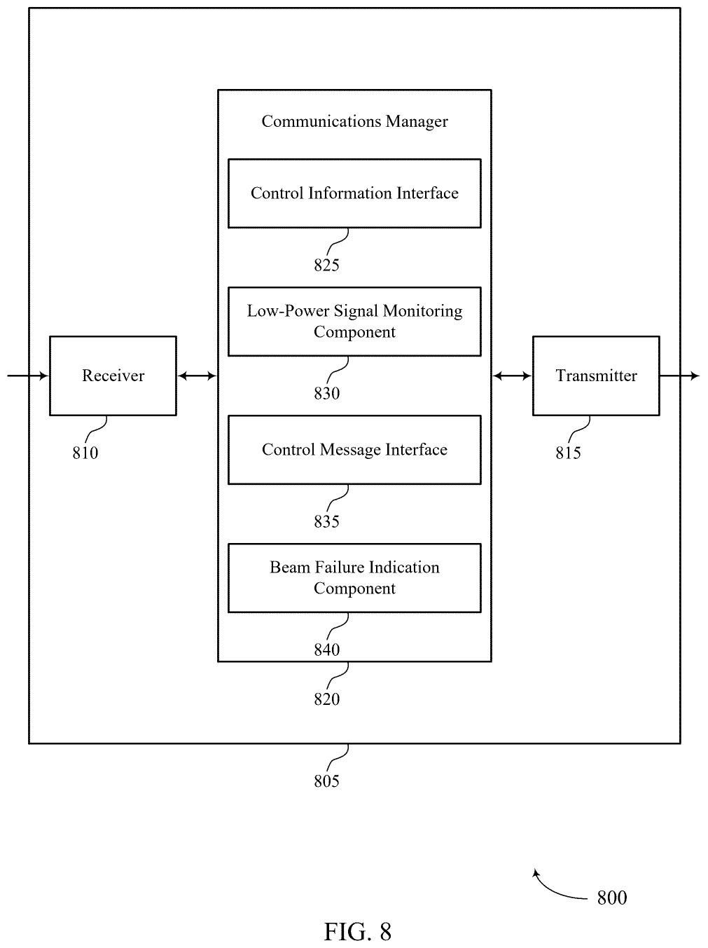

FIG. 8 shows a block diagram 800 of a device 805 that supports low-power signaling and beam failure detection in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to low-power signaling and beam failure detection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to low-power signaling and beam failure detection). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of low-power signaling and beam failure detection as described herein. For example, the communications manager 820 may include a control information interface 825, a low-power signal monitoring component 830, a control message interface 835, a beam failure indication component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control information interface 825 is capable of, configured to, or operable to support a means for receiving first control information indicative of a set of resources that the UE is to monitor for a low-power wake-up signal. The low-power signal monitoring component 830 is capable of, configured to, or operable to support a means for monitoring, using an auxiliary radio of the UE, the set of resources for the low-power wake-up signal in accordance with the first control information. The control message interface 835 is capable of, configured to, or operable to support a means for transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

Additionally, or alternatively, the communications manager 820 may support wireless communications in accordance with examples as disclosed herein. The control information interface 825 is capable of, configured to, or operable to support a means for receiving first control information indicative of a set of resources that the UE is to monitor for one or more low-power signals. The low-power signal monitoring component 830 is capable of, configured to, or operable to support a means for monitoring, using a first beam and an auxiliary radio of the UE, the set of resources for the one or more low-power signals in accordance with the first control information. The beam failure indication component 840 is capable of, configured to, or operable to support a means for transmitting, using the auxiliary radio or a primary radio of the UE and based on the one or more low-power signals failing to satisfy a measurement threshold on the first beam, a message indicative of the one or more low-power signals failing to satisfy the measurement threshold.

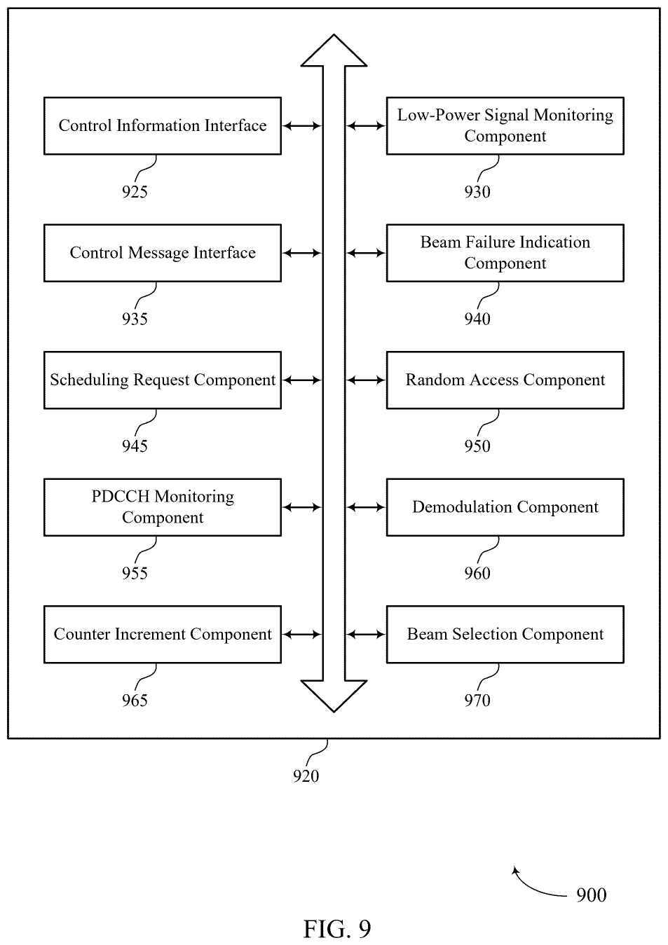

FIG. 9 shows a block diagram 900 of a communications manager 920 that supports low-power signaling and beam failure detection in accordance with one or more aspects of the present disclosure. The communications manager 920 may be an example of aspects of a communications manager 720, a communications manager 820, or both, as described herein. The communications manager 920, or various components thereof, may be an example of means for performing various aspects of low-power signaling and beam failure detection as described herein. For example, the communications manager 920 may include a control information interface 925, a low-power signal monitoring component 930, a control message interface 935, a beam failure indication component 940, a scheduling request component 945, a random access component 950, a PDCCH monitoring component 955, a demodulation component 960, a counter increment component 965, a beam selection component 970, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The control information interface 925 is capable of, configured to, or operable to support a means for receiving first control information indicative of a set of resources that the UE is to monitor for a low-power wake-up signal. The low-power signal monitoring component 930 is capable of, configured to, or operable to support a means for monitoring, using an auxiliary radio of the UE, the set of resources for the low-power wake-up signal in accordance with the first control information. The control message interface 935 is capable of, configured to, or operable to support a means for transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

In some examples, to support transmitting the control message, the scheduling request component 945 is capable of, configured to, or operable to support a means for transmitting an uplink scheduling request message indicative of the UE failing to detect the low-power wake-up signal during the set of resources.

In some examples, to support transmitting the control message, the random access component 950 is capable of, configured to, or operable to support a means for transmitting, in a random access channel, a signal including a random access channel preamble, where the signal is indicative of the UE failing to detect the low-power wake-up signal during the set of resources.

In some examples, the control message is transmitted based on the UE failing to detect the low-power wake-up signal in a threshold quantity of resources of the set of resources.

In some examples, the control information interface 925 is capable of, configured to, or operable to support a means for receiving second control information indicative of the threshold quantity of resources associated with triggering transmission of the control message indicative of the UE failing to detect the low-power wake-up signal during the set of resources.

In some examples, the low-power signal monitoring component 930 is capable of, configured to, or operable to support a means for refraining, based on failing to detect the low-power wake-up signal, from monitoring for the low-power wake-up signal during one or more resources of the set of resources.

In some examples, the PDCCH monitoring component 955 is capable of, configured to, or operable to support a means for monitoring, based on failing to detect the low-power wake-up signal and using the primary radio of the UE, for control messages during a physical downlink control channel resource.

In some examples, to support monitoring for the control messages, the PDCCH monitoring component 955 is capable of, configured to, or operable to support a means for monitoring for the control messages during an on duration of a discontinuous reception cycle.

In some examples, the control information interface 925 is capable of, configured to, or operable to support a means for receiving second control information that indicates that the UE is to monitor for the control messages during a physical downlink control channel resource in response to failing to detect the low-power wake-up signal, where the UE monitors for the control messages based on the second control information.

In some examples, the control information interface 925 is capable of, configured to, or operable to support a means for receiving, in response to transmitting the control message, second control information that indicates that the UE is to deactivate low-power wake-up signal monitoring during the set of resources.

In some examples, the low-power wake-up signal includes an on-off keying signal, and the demodulation component 960 is capable of, configured to, or operable to support a means for attempting to demodulate, using the auxiliary radio, the low-power wake-up signal without using inverse fast Fourier transform based on one or more characteristics associated with the low-power wake-up signal.

Additionally, or alternatively, the communications manager 920 may support wireless communications in accordance with examples as disclosed herein. In some examples, the control information interface 925 is capable of, configured to, or operable to support a means for receiving first control information indicative of a set of resources that the UE is to monitor for one or more low-power signals. In some examples, the low-power signal monitoring component 930 is capable of, configured to, or operable to support a means for monitoring, using a first beam and an auxiliary radio of the UE, the set of resources for the one or more low-power signals in accordance with the first control information. The beam failure indication component 940 is capable of, configured to, or operable to support a means for transmitting, using the auxiliary radio or a primary radio of the UE and based on the one or more low-power signals failing to satisfy a measurement threshold on the first beam, a message indicative of the one or more low-power signals failing to satisfy the measurement threshold.

In some examples, the counter increment component 965 is capable of, configured to, or operable to support a means for incrementing a beam failure counter based on the one or more low-power signals failing to satisfy the measurement threshold, where the message is transmitted based on the beam failure counter satisfying a beam failure counter threshold.

In some examples, the UE measures the one or more low-power signals for beam failure detection based on the first control information indicative of the set of resources that the UE is to monitor for the one or more low-power signals.

In some examples, the one or more low-power signals include one or more low-power wake-up signals, one or more low-power synchronization signals, or both.

In some examples, the control information interface 925 is capable of, configured to, or operable to support a means for receiving second control information indicative of a set of candidate beam reference signals that includes the one or more low-power signals.

In some examples, the second control information is indicative of the measurement threshold for the one or more low-power signals that is different from a second measurement threshold associated with other candidate beam reference signals included in the set of candidate beam reference signals.

In some examples, the beam selection component 970 is capable of, configured to, or operable to support a means for selecting, based on the one or more low-power signals failing to satisfy the measurement threshold, a second beam for communications, where the message is transmitted using the second beam.

In some examples, to support selecting the second beam, the beam selection component 970 is capable of, configured to, or operable to support a means for selecting the second beam based on a measurement of the second beam satisfying a second beam measurement threshold associated with the second beam.

In some examples, the second beam is associated with a second low-power signal included in a candidate beam reference signal list.

In some examples, the message indicates a beam failure on the first beam.

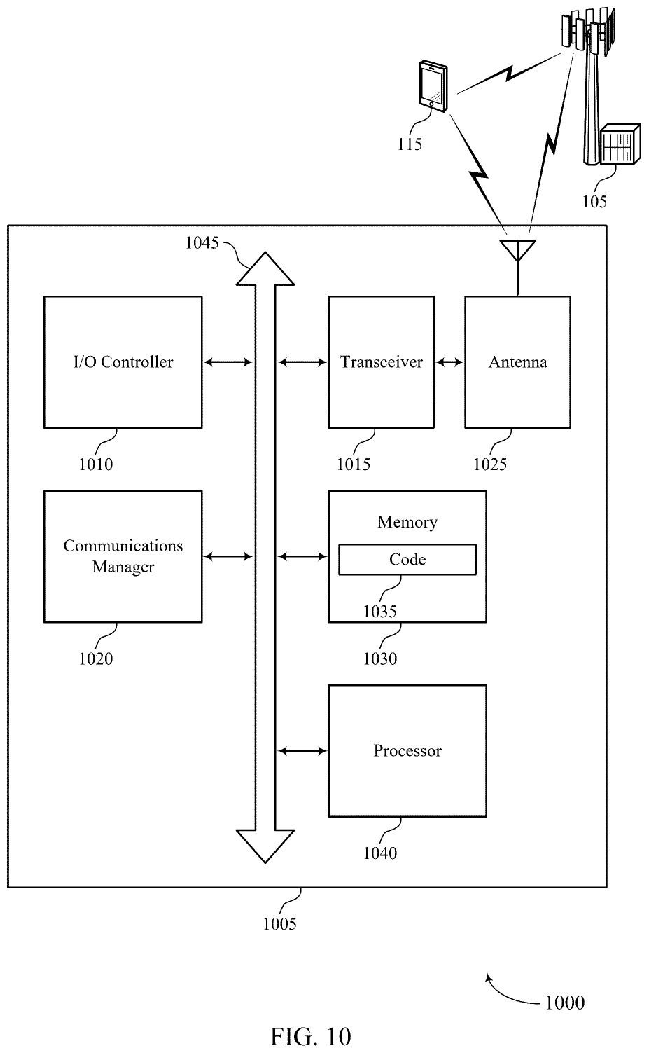

FIG. 10 shows a diagram of a system 1000 including a device 1005 that supports low-power signaling and beam failure detection in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting low-power signaling and beam failure detection). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving first control information indicative of a set of resources that the UE is to monitor for a low-power wake-up signal. The communications manager 1020 is capable of, configured to, or operable to support a means for monitoring, using an auxiliary radio of the UE, the set of resources for the low-power wake-up signal in accordance with the first control information. The communications manager 1020 is capable of, configured to, or operable to support a means for transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources.

Additionally, or alternatively, the communications manager 1020 may support wireless communications in accordance with examples as disclosed herein. For example, the communications manager 1020 is capable of, configured to, or operable to support a means for receiving first control information indicative of a set of resources that the UE is to monitor for one or more low-power signals. The communications manager 1020 is capable of, configured to, or operable to support a means for monitoring, using a first beam and an auxiliary radio of the UE, the set of resources for the one or more low-power signals in accordance with the first control information. The communications manager 1020 is capable of, configured to, or operable to support a means for transmitting, using the auxiliary radio or a primary radio of the UE and based on the one or more low-power signals failing to satisfy a measurement threshold on the first beam, a message indicative of the one or more low-power signals failing to satisfy the measurement threshold.

By including or configuring the communications manager 1020 in accordance with examples as described herein, the device 1005 may support techniques for reduced power consumption (longer battery life) and more efficient utilization of communication resources

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of low-power signaling and beam failure detection as described herein, or the at least one processor 1040 and the at least one memory 1030 may be otherwise configured to, individually or collectively, perform or support such operations.

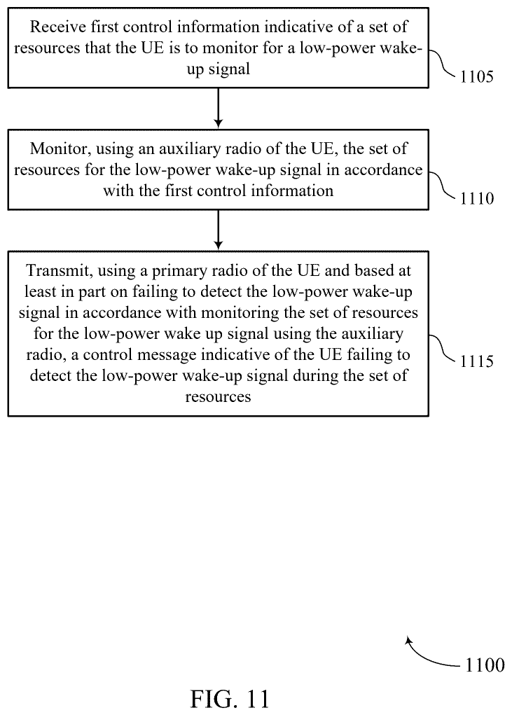

FIG. 11 shows a flowchart illustrating a method 1100 that supports low-power signaling and beam failure detection in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving first control information indicative of a set of resources that the UE is to monitor for a low-power wake-up signal. The operations of 1105 may be performed in accordance with examples as disclosed herein. In some examples, aspects of the operations of 1105 may be performed by a control information interface 925 as described with reference to FIG. 9.

At 1110, the method may include monitoring, using an auxiliary radio of the UE, the set of resources for the low-power wake-up signal in accordance with the first control information. The operations of 1110 may be performed in accordance with examples as disclosed herein. In some examples, aspects of the operations of 1110 may be performed by a low-power signal monitoring component 930 as described with reference to FIG. 9.

At 1115, the method may include transmitting, using a primary radio of the UE and based on failing to detect the low-power wake-up signal in accordance with monitoring the set of resources for the low-power wake-up signal using the auxiliary radio, a control message indicative of the UE failing to detect the low-power wake-up signal during the set of resources. The operations of 1115 may be performed in accordance with examples as disclosed herein. In some examples, aspects of the operations of 1115 may be performed by a control message interface 935 as described with reference to FIG. 9.

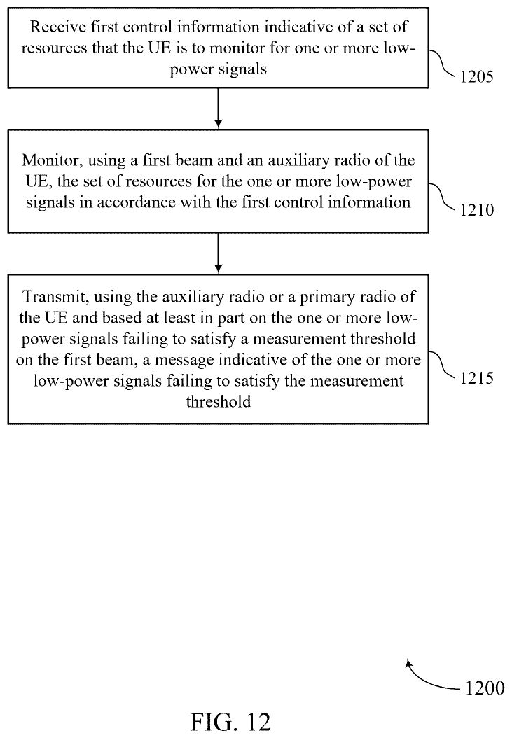

FIG. 12 shows a flowchart illustrating a method 1200 that supports low-power signaling and beam failure detection in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving first control information indicative of a set of resources that the UE is to monitor for one or more low-power signals. The operations of 1205 may be performed in accordance with examples as disclosed herein. In some examples, aspects of the operations of 1205 may be performed by a control information interface 925 as described with reference to FIG. 9.

At 1210, the method may include monitoring, using a first beam and an auxiliary radio of the UE, the set of resources for the one or more low-power signals in accordance with the first control information. The operations of 1210 may be performed in accordance with examples as disclosed herein. In some examples, aspects of the operations of 1210 may be performed by a low-power signal monitoring component 930 as described with reference to FIG. 9.

At 1215, the method may include transmitting, using the auxiliary radio or a primary radio of the UE and based on the one or more low-power signals failing to satisfy a measurement threshold on the first beam, a message indicative of the one or more low-power signals failing to satisfy the measurement threshold. The operations of 1215 may be performed in accordance with examples as disclosed herein. In some examples, aspects of the operations of 1215 may be performed by a beam failure indication component 940 as described with reference to FIG. 9.

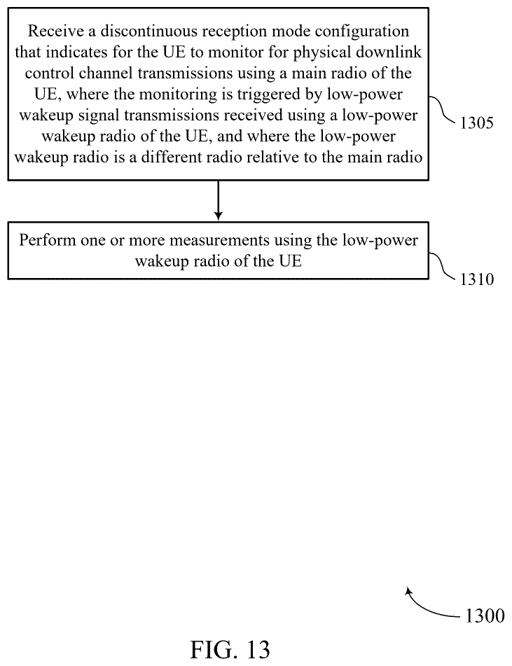

FIG. 13 shows a flowchart illustrating a method 1300 that supports low-power signaling and beam failure detection in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a discontinuous reception mode configuration that indicates for the UE to monitor for PDCCH transmissions using a main radio of the UE, where the monitoring is triggered by LP-WUS transmissions received using a LP-WUR of the UE, and where the LP-WUR is a different radio relative to the main radio. The operations of 1305 may be performed in accordance with examples as disclosed herein. In some examples, aspects of the operations of 1305 may be performed by control information interface 825 as described with reference to FIG. 8.

At 1310, the method may include performing one or more measurements using the LP-WUR of the UE. The operations of 1310 may be performed in accordance with examples as disclosed herein. In some examples, aspects of the operations of 1310 may be performed by a low-power signal monitoring component 830 as described with reference to FIG. 8.

The following provides an overview of aspects of the present disclosure:
Aspect 1: A method for wireless communications at a UE, comprising: receiving first control information indicative of a set of resources that the UE is to monitor for a low-power wake-up signal; monitoring, using an auxiliary radio of the UE, the set of resources for the low-power wake-up signal in accordance with the first control information; and transmitting, using a primary radio of the UE and based at least in part on failing to detect the low-power wake-up signal in accordance with monitoring the set of resources for the low-power wake-up signal using the auxiliary radio, a control message indicative of the UE failing to detect the low-power wake-up signal during the set of resources.
Aspect 2: The method of aspect 1, wherein transmitting the control message comprises: transmitting an uplink scheduling request message indicative of the UE failing to detect the low-power wake-up signal during the set of resources.
Aspect 3: The method of any of aspects 1 through 2, wherein transmitting the control message comprises: transmitting, in a random access channel, a signal comprising a random access channel preamble, wherein the signal is indicative of the UE failing to detect the low-power wake-up signal during the set of resources.
Aspect 4: The method of any of aspects 1 through 3, wherein the control message is transmitted based at least in part on the UE failing to detect the low-power wake-up signal in a threshold quantity of resources of the set of resources.
Aspect 5: The method of aspect 4, further comprising: receiving second control information indicative of the threshold quantity of resources associated with triggering transmission of the control message indicative of the UE failing to detect the low-power wake-up signal during the set of resources.
Aspect 6: The method of any of aspects 1 through 5, further comprising: refraining, based at least in part on failing to detect the low-power wake-up signal, from monitoring for the low-power wake-up signal during one or more resources of the set of resources.
Aspect 7: The method of any of aspects 1 through 6, further comprising: monitoring, based at least in part on failing to detect the low-power wake-up signal and using the primary radio of the UE, for control messages during a physical downlink control channel resource.
Aspect 8: The method of aspect 7, wherein monitoring for the control messages comprises: monitoring for the control messages during an on duration of a discontinuous reception cycle.
Aspect 9: The method of any of aspects 7 through 8, further comprising: receiving second control information that indicates that the UE is to monitor for the control messages during a physical downlink control channel resource in response to failing to detect the low-power wake-up signal, wherein the UE monitors for the control messages based at least in part on the second control information.
Aspect 10: The method of any of aspects 1 through 9, further comprising: receiving, in response to transmitting the control message, second control information that indicates that the UE is to deactivate low-power wake-up signal monitoring during the set of resources.
Aspect 11: The method of any of aspects 1 through 10, wherein the low-power wake-up signal comprises an on-off keying signal, the method further comprising: attempting to demodulate, using the auxiliary radio, the low-power wake-up signal without using inverse fast Fourier transform based at least in part on one or more characteristics associated with the low-power wake-up signal.
Aspect 12: A method for wireless communications at a UE, comprising: receiving first control information indicative of a set of resources that the UE is to monitor for one or more low-power signals; monitoring, using a first beam and an auxiliary radio of the UE, the set of resources for the one or more low-power signals in accordance with the first control information; and transmitting, using the auxiliary radio or a primary radio of the UE and based at least in part on the one or more low-power signals failing to satisfy a measurement threshold on the first beam, a message indicative of the one or more low-power signals failing to satisfy the measurement threshold.
Aspect 13: The method of aspect 12, further comprising: incrementing a beam failure counter based at least in part on the one or more low-power signals failing to satisfy the measurement threshold, wherein the message is transmitted based at least in part on the beam failure counter satisfying a beam failure counter threshold.
Aspect 14: The method of any of aspects 12 through 13, wherein the UE measures the one or more low-power signals for beam failure detection based at least in part on the first control information indicative of the set of resources that the UE is to monitor for the one or more low-power signals.
Aspect 15: The method of any of aspects 12 through 14, wherein the one or more low-power signals comprise one or more low-power wake-up signals, one or more low-power synchronization signals, or both.
Aspect 16: The method of any of aspects 12 through 15, further comprising: receiving second control information indicative of a set of candidate beam reference signals that comprises the one or more low-power signals.
Aspect 17: The method of aspect 16, wherein the second control information is indicative of the measurement threshold for the one or more low-power signals that is different from a second measurement threshold associated with other candidate beam reference signals included in the set of candidate beam reference signals.
Aspect 18: The method of any of aspects 12 through 17, further comprising: selecting, based at least in part on the one or more low-power signals failing to satisfy the measurement threshold, a second beam for communications, wherein the message is transmitted using the second beam.
Aspect 19: The method of aspect 18, wherein selecting the second beam comprises: selecting the second beam based at least in part on a measurement of the second beam satisfying a second beam measurement threshold associated with the second beam.
Aspect 20: The method of any of aspects 18 through 19, wherein the second beam is associated with a second low-power signal included in a candidate beam reference signal list.
Aspect 21: The method of any of aspects 12 through 20, wherein the message indicates a beam failure on the first beam.
Aspect 22: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 11.
Aspect 23: A method for wireless communication at a UE, comprising: receiving a discontinuous reception mode configuration that indicates for the UE to monitor for PDCCH transmissions using a main radio of the UE, wherein the monitoring is triggered by LP-WUS transmissions received using a LP-WUR of the UE, and wherein the LP-WUR is a different radio relative to the main radio; and performing one or more measurements using the LP-WUR of the UE.
Aspect 24: The method of aspect 14, wherein performing the one or more measurements using the LP-WUR is based at least in part on the UE being configured for discontinuous reception mode operations and configured for PDCCH monitoring based on a LP-WUS trigger.
Aspect 25: The method of any of aspects 14 through 15, wherein the one or more measurements comprise one or more of a RRM measurement, a RLM measurement, a BFD measurement, or a CSI measurement using the LP-WUR of the UE.
Aspect 26: A UE for wireless communications, comprising at least one means for performing a method of any of aspects 1 through 11.
Aspect 27: A non-transitory computer-readable medium storing code for wireless communications, the code comprising instructions executable by one or more processors (e.g., directly, indirectly, after pre-processing, without pre-processing) to perform a method of any of aspects 1 through 11.
Aspect 28: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 12 through 21.
Aspect 29: A UE for wireless communications, comprising at least one means for performing a method of any of aspects 12 through 21.
Aspect 30: A non-transitory computer-readable medium storing code for wireless communications, the code comprising instructions executable by one or more processors (e.g., directly, indirectly, after pre-processing, without pre-processing) to perform a method of any of aspects 12 through 21.
Aspect 31: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 23 through 25.
Aspect 32: A UE for wireless communications, comprising at least one means for performing a method of any of aspects 23 through 25.
Aspect 33: A non-transitory computer-readable medium storing code for wireless communications, the code comprising instructions executable by one or more processors (e.g., directly, indirectly, after pre-processing, without pre-processing) to perform a method of any of aspects 23 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

what is claimed is:

1. A user equipment (UE), comprising:
one or more memories storing processor-executable code; and
one or more processors coupled with the one or more memories and individually or collectively operable to execute the code to cause the UE to:
receive first control information indicative of a set of resources that the UE is to monitor for a low-power wake-up signal;
monitor, using an auxiliary radio of the UE, the set of resources for the low-power wake-up signal in accordance with the first control information; and
transmit, using a primary radio of the UE and based at least in part on failing to detect the low-power wake-up signal in accordance with monitoring the set of resources for the low-power wake-up signal using the auxiliary radio, a control message indicative of the UE failing to detect the low-power wake-up signal during the set of resources.

2. The UE of claim 1, wherein, to transmit the control message, the one or more processors are individually or collectively operable to execute the code to cause the UE to:
transmit an uplink scheduling request message indicative of the UE failing to detect the low-power wake-up signal during the set of resources.

3. The UE of claim 1, wherein, to transmit the control message, the one or more processors are individually or collectively operable to execute the code to cause the UE to:
transmit, in a random access channel, a signal comprising a random access channel preamble, wherein the signal is indicative of the UE failing to detect the low-power wake-up signal during the set of resources.

4. The UE of claim 1, wherein the control message is transmitted based at least in part on the UE failing to detect the low-power wake-up signal in a threshold quantity of resources of the set of resources.

5. The UE of claim 4, wherein the one or more processors are individually or collectively further operable to execute the code to cause the UE to:
receive second control information indicative of the threshold quantity of resources associated with triggering transmission of the control message indicative of the UE failing to detect the low-power wake-up signal during the set of resources.

6. The UE of claim 1, wherein the one or more processors are individually or collectively further operable to execute the code to cause the UE to:
refrain, based at least in part on failing to detect the low-power wake-up signal, from monitoring for the low-power wake-up signal during one or more resources of the set of resources.

7. The UE of claim 1, wherein the one or more processors are individually or collectively further operable to execute the code to cause the UE to:
monitor, based at least in part on failing to detect the low-power wake-up signal and using the primary radio of the UE, for control messages during a physical downlink control channel resource.

8. The UE of claim 7, wherein, to monitor for the control messages, the one or more processors are individually or collectively operable to execute the code to cause the UE to:
monitor for the control messages during an on duration of a discontinuous reception cycle.

9. The UE of claim 7, wherein the one or more processors are individually or collectively further operable to execute the code to cause the UE to:
receive second control information that indicates that the UE is to monitor for the control messages during a physical downlink control channel resource in response to failing to detect the low-power wake-up signal, wherein the UE monitors for the control messages based at least in part on the second control information.

10. The UE of claim 1, wherein the one or more processors are individually or collectively further operable to execute the code to cause the UE to:
receive, in response to transmitting the control message, second control information that indicates that the UE is to deactivate low-power wake-up signal monitoring during the set of resources.

11. The UE of claim 1, wherein the low-power wake-up signal comprises an on-off keying signal, and the one or more processors are individually or collectively further operable to execute the code to cause the UE to:
attempt to demodulate, using the auxiliary radio, the low-power wake-up signal without using inverse fast Fourier transform based at least in part on one or more characteristics associated with the low-power wake-up signal.

12. A user equipment (UE), comprising:
one or more memories storing processor-executable code; and
one or more processors coupled with the one or more memories and individually or collectively operable to execute the code to cause the UE to:
receive first control information indicative of a set of resources that the UE is to monitor for one or more low-power signals;
monitor, using a first beam and an auxiliary radio of the UE, the set of resources for the one or more low-power signals in accordance with the first control information; and
transmit, using the auxiliary radio or a primary radio of the UE and based at least in part on the one or more low-power signals failing to satisfy a measurement threshold on the first beam, a message indicative of the one or more low-power signals failing to satisfy the measurement threshold.

13. The UE of claim 12, wherein the one or more processors are individually or collectively further operable to execute the code to cause the UE to:
increment a beam failure counter based at least in part on the one or more low-power signals failing to satisfy the measurement threshold, wherein the message is transmitted based at least in part on the beam failure counter satisfying a beam failure counter threshold.

14. The UE of claim 12, wherein the UE measures the one or more low-power signals for beam failure detection based at least in part on the first control information indicative of the set of resources that the UE is to monitor for the one or more low-power signals.

15. The UE of claim 12, wherein the one or more low-power signals comprise one or more low-power wake-up signals, one or more low-power synchronization signals, or both.

16. The UE of claim 12, wherein the one or more processors are individually or collectively further operable to execute the code to cause the UE to:
receive second control information indicative of a set of candidate beam reference signals that comprises the one or more low-power signals.

17. The UE of claim 16, wherein the second control information is indicative of the measurement threshold for the one or more low-power signals that is different from a second measurement threshold associated with other candidate beam reference signals included in the set of candidate beam reference signals.

18. The UE of claim 12, wherein the one or more processors are individually or collectively further operable to execute the code to cause the UE to:
select, based at least in part on the one or more low-power signals failing to satisfy the measurement threshold, a second beam for communications, wherein the message is transmitted using the second beam.

19. The UE of claim 18, wherein, to select the second beam, the one or more processors are individually or collectively operable to execute the code to cause the UE to:
select the second beam based at least in part on a measurement of the second beam satisfying a second beam measurement threshold associated with the second beam.

20. A method for wireless communications at a user equipment (UE), comprising:
receiving first control information indicative of a set of resources that the UE is to monitor for a low-power wake-up signal;
monitoring, using an auxiliary radio of the UE, the set of resources for the low-power wake-up signal in accordance with the first control information; and
transmitting, using a primary radio of the UE and based at least in part on failing to detect the low-power wake-up signal in accordance with monitoring the set of resources for the low-power wake-up signal using the auxiliary radio, a control message indicative of the UE failing to detect the low-power wake-up signal during the set of resources.
